(19) United States
(12) Patent Application Publication
(10) Pub. No.: US 2002/0111573 A1
(43) Pub. Date: Aug. 15, 2002

(54) Massage therapy device

(76) Inventor: Shih-Chin Teng, Taichung Hsien (TW)

Correspondence Address: Dougherty & Troxell, ONE SKYLINE PLACE, SUITE 1404, 5205 LEESBURG PIKE, FALLS CHURCH, VA, 22041, US

(21) Appl. No.: 09/782,048

(22) Filed: Feb. 14, 2001

(51) Int. Cl. A61H 7/00

(52) U.S. Cl. 601/137; 601/136

(57) ABSTRACT

The invention, a massage therapy device, comprises of certain amount of evenly mixed hard particles and elastic particles and a therapy device majority equipping a container to contain the evenly mixed hard particles and elastic particles and superficial air inlets and outlets. By controlling the amount of evenly mixed hard particles and elastic particles inside the therapy device majority, the interior of the entire therapy device majority is under certain degree of saturation or swelling. One may arbitrarily squeeze, clutch, push, pat, and rub the palm, finger, toe, face and various portions on the entire body under the timing control of optimal time retard, space retard, active force and reaction force. The device may arbitrarily strengthen joint massage, finger activation, reflection massage for brain tissue and other organs to further vitalize the skin and to achieve optimal massage and therapy effects in avoiding blood blockage for the entire body. Especially, a user can not only ideally utilize the device for manual massage by imitating traditional optimal massage, but also achieve optimal massage and therapy effects.

### BACKGROUND OF THE INVENTION

1) Field of the Invention

The invention is developed to overcome the various defectives for traditional massage devices. Especially, according the structure of the invention, it provides massage for the non-fixture spots of the entire human body in arbitrary space and period of time under the control of optimal time retard, space retard, and active force and reaction force.

2) Description of the Prior Art

People living in the society work hard day and night in the young age to become rich. Very frequently they do not care their own body health. As a result, most of the objectives are achieved by constantly spending time, energy and, spirit, however, they do not care the body health at all. Only until the aged period, they realize that many things in the life, such as the body health are much more important than the wealth. When getting old, they desire the recovery of vital health in the young age. The situation is very perplexing. For those people who are able to predict the above situation, they expect the aids of current massage devices to live longer, when they are pursuing wealth.

Current massage methods can be categorized as following two types:

1. Manual massage: The advantage is as follows:

(1) The entire pressure exertion is fully controlled by the massage conductor. Thus, he or she can provide soft massage with strength to achieve ideal massage effect.

(2) It is very convenient to provide massage service for the entire body.

The disadvantage is as follows:

(1) The power of massage is limited.

(2) The person conducting massage must be very professional and knowledgeable regarding the points in human body, thus unnecessary injury will not occur.

(3) The force exerted is not easily controlled. Minor force exertion leads to minor massage effect, however, heavy force exertion leads to unnecessary injury.

(4) The massage takes a lot of exertion and is unable to last very long time.

(5) It is very difficult to find the painful spots.

(6) The life (chih, breath) of the massage conductor will be hurt. The situation is obvious, especially for those heavily sick.

2. External compulsory massage (electric massage, mechanic massage, ultra infrared-ray massage): The advantage is as follows:

(1) Exercise effect can be achieved for the lazy people.

The disadvantage is as follows:

(1) The massage device is either too hard or too soft, thus, it is not competitive to the basic conditions for manual massage. The effect of manual massage is not achievable.

(2) Regular massage (only a few kinds of massage methods) is not able to take case the suddenly varied life (chih, breath).

(3) Prior to understanding of the circulation of chih or breath, the massage lacking insight such as vibration, rotation, rolling movement, pressure exertion, ultra infrared-ray, light, and heat exertion will result injury in certain degree.

(4) The actual painful spots are not easy to be found.

The invention made improvement regarding the defectives of the prior massage products, however, it maintained the advantages of the products.

### SUMMARY OF THE INVENTION

The primary objective of the invention is to provide a kind of massage therapy with characteristics as achievement of optimal massage and therapy effects by timing control of optimal time retard, space retard, optimal force and reaction force for non-fixed massage regarding the entire human body.

The followings are brief characteristic description of embodiments of the invention structure for committee's better understanding in the structural characteristics and operations of the invention.

### BRIEF DESCRIPTION OF THE DRAWINGS

FIG. 1 is the sectional exploded drawing of the structure of invention.

FIG. 2 is a drawing of the embodiment for the structure of invention.

FIG. 3 is another drawing of the embodiment for the structure of invention.

FIG. 4 is another sectional exploded drawing of the embodiment for the structure of invention.

FIG. 5-A is another drawing of the embodiment for the structure of invention prior to pressure exertion.

FIG. 5-B is another drawing of the embodiment for the structure of invention under pressure.

FIG. 5-C is another drawing of the embodiment for the structure of invention after relieving pressure.

FIG. 6 is a pressure curve drawing of the embodiment for the structure of the invention.

FIG. 7 is an optimal time retard drawing of the embodiment for the structure of the invention.

FIG. 8 is the isometric drawing of the embodiment of the structure of the invention.

### DETAILED DESCRIPTION OF THE PREFERRED EMBODIMENT

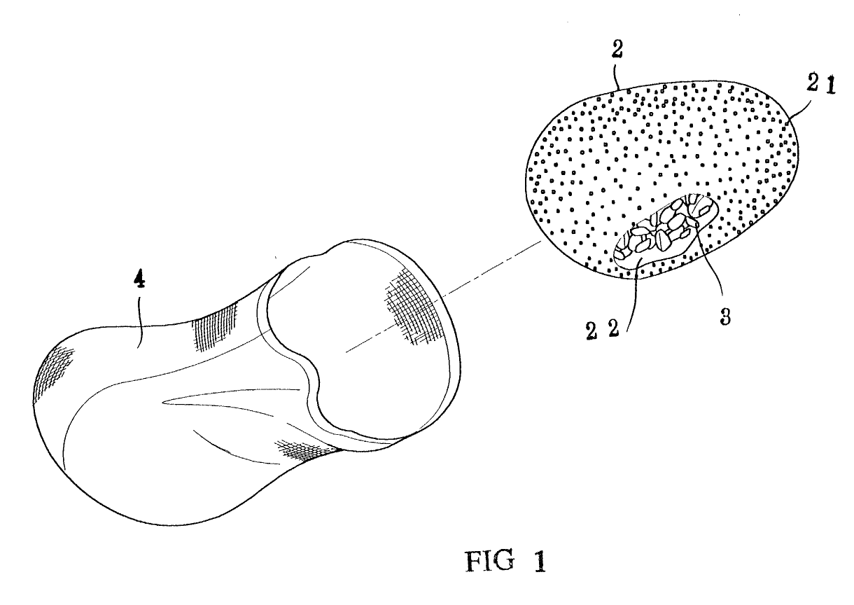

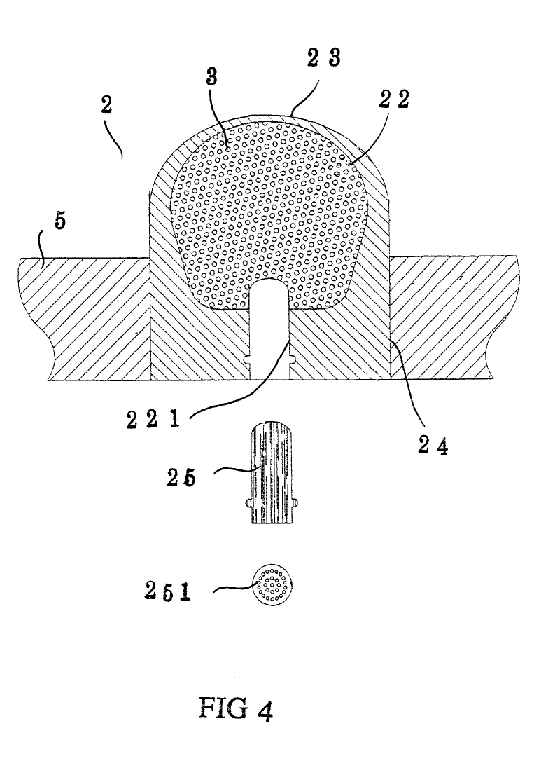

Please refer FIGS. 1 and 4. The invention, a massage therapy device, comprises of a therapy majority 2 with superficial air inlet and outlet 21 and internal empty container 22, hard particles without sharp angle, such as porcelain stone, gravel, steel ball, grain, etc., which are evenly mixed fine and stuffed inside the therapy majority 2, and elastic particles 3 made of ultra elastic material such as rubber, silicon, glue, etc. The hard particles are in 0.5 to 3-mm diameter and the amount of the particles depends on the therapy spots of the human body. The best choice is porcelain stone, the primary source of the massage particles. The elastic particles are in 0.5 to 3-mm diameter and the secondary source of massage source. The particles strengthen the restore, also provide three optimal effects, i.e. time retard, space retard, active force and reaction force.

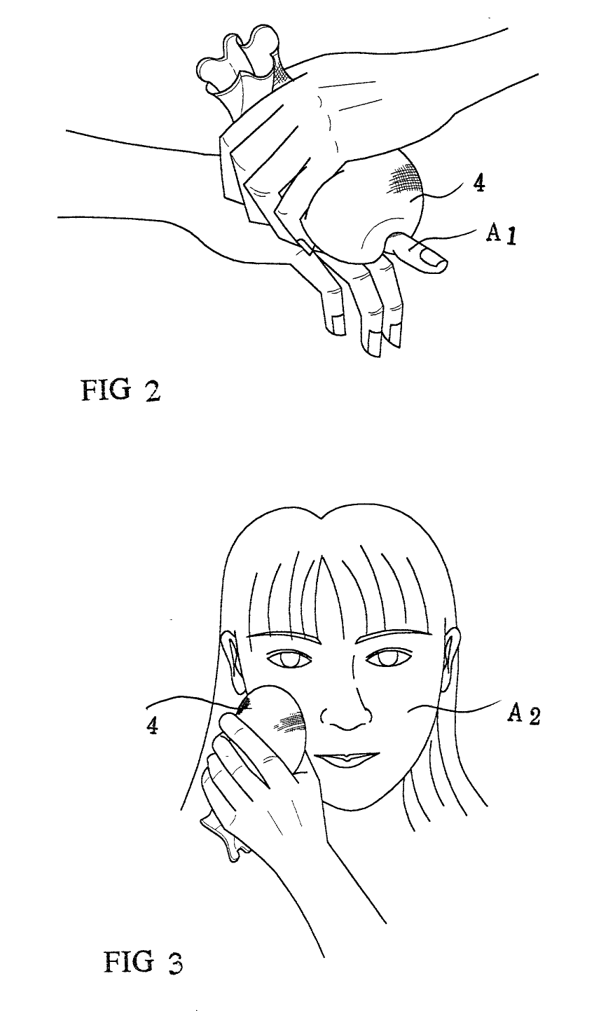

Please refer FIGS. 1, 2, and 3 for the embodiments of the structure of the invention. The air inlets and outlets on the therapy device 2 are evenly distributed in stitch state on the entire surface of the therapy device 2. Evenly mix the hard and elastic particles 3 each with half volume of that for the therapy device 2 and add the particles into the therapy device. Finally, wrap a thin layer of an external bag 4 made of fine soft cloth around therapy device 2 for optimal touch, friction, easy cleaning, and the protection of the therapy device 2. The hard and elastic particles 3 stuffed inside the massage therapy device 2 form an activity space in the massage therapy device. Relatively, the entire massage therapy device 2 forming an extension variation space and arbitrary deformation can be utilized to arbitrarily push, squeeze, rub, clutch, and pat those body spots, especially, the finger joints A1 as shown in FIG. 2, or toe joints on the foot, or the face A2 with multiple contours as shown in FIG. 3, and those spots not reachable for traditional large-scale massage device. It arbitrarily strengthens joint massage, finger activation, reflection massage for other organs to further vitalize the skin and to achieve optimal massage and therapy effects in avoiding blood blockage for the entire body.

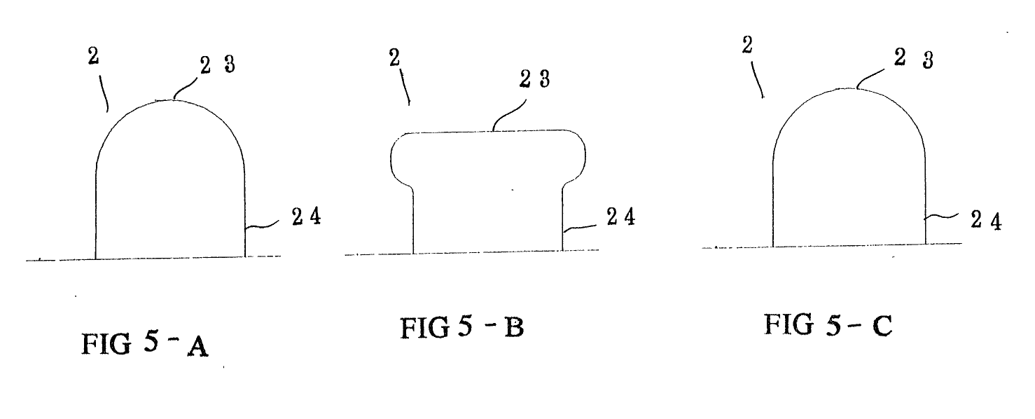

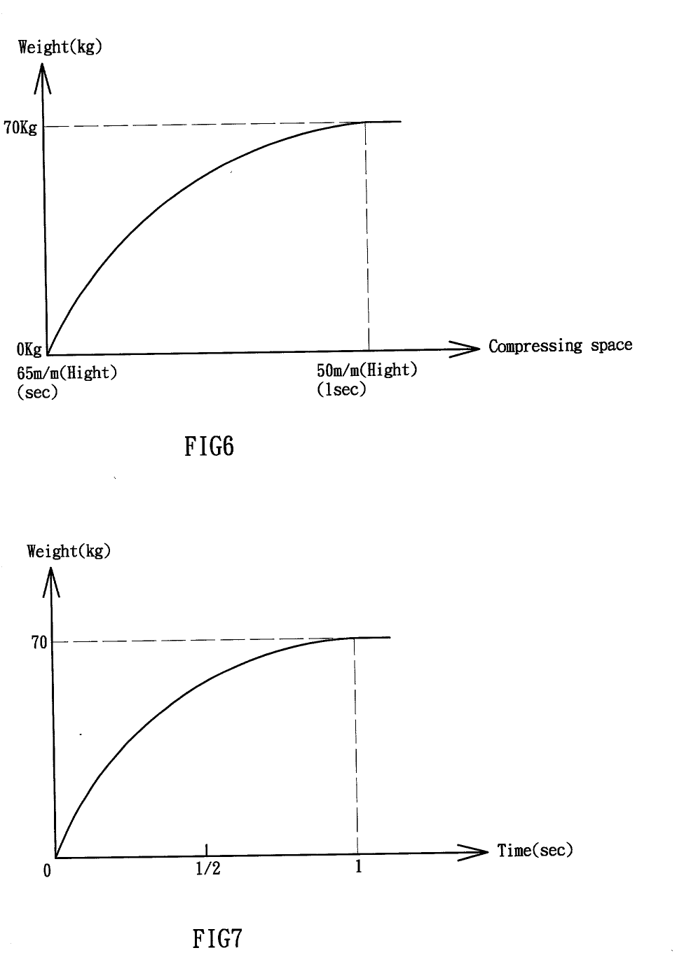

Moreover, please refer FIGS. 4, 5-A, 5-B, 6, and 7, another embodiment for the structure of the invention. The external layer of massage therapy device 2 with certain elasticity can be in round or oval shape on the top end 23 and cylinder or oval column shape on the bottom end 24 with gradually thickness increase. A position cork 25 located on an air inlet and outlet chokes the stuff opening 221 on the container 22 of the massage therapy device 2. Thus, it is very convenient for a user to directly grasp the massage therapy device and to conduct direct massage on any portion of the body of the user or the others. The entire massage therapy device 2 is characterized as specially-designed elastic soft rubber, which is round or oval on the top end 22 and is in cylinder or oval column shape on bottom end 23, the internally stuffed particular hard and elastic particles 3, the positioning cork 25 blocking massage therapy device. The cork 25 equips multiple air inlets and outlets 251. It can not only completely block the evenly mixed hard particles and elastic particles in the empty container in the massage therapy device but also provides an optimal space retard as shown in FIGS. 5-A, 5-3B, and 5-C, optimal active force and reaction force as shown in FIG. 6 under the saturation compression on the entire particles. According various body situations, a user may ideally adjust the device to fully mimic manual massage and provide optimal massage without time and space limit for spirit release and convenient massage.

As shown in FIG. 8, one may utilize the massage therapy device shown in FIG. 4 to conduct massage for particular spots, such as the foot, back, and the waist. Also, by fastening the device onto a fixture board 5, the device strengthens the elasticity and comfort during the entire process of massage.

In summary, comparing with the prior product, the invention is much more convenient and effective. Especially, it can not only provide manual massage imitating traditional optimal massage, but also achieve better massage and therapy effects.

The above explanation is a substantial embodiment of the invention, which provides greater practical performance and simplification than products of prior art. Furthermore, the present invention meets all new patent application requirements and is lawfully submitted for review and the granting of the commensurate patent rights to thereby encourage the spirit of invention and its rightful protection under the patent law.

1. The invention, a kind of massage therapy device comprises of a therapy majority with superficial air inlet and outlet and internal empty container, evenly mixed hard particles and elastic particles, which are put into the majority depending on the spot exerted to control the amount of stuffed volume; furthermore, based on the above assembly, it is characterized as mimicking the traditional optimal manual massage and achieving better massage and therapy effects.

2. As mentioned in claim 1 of a kind of massage therapy device, the air inlets and outlets on the device are evenly distributed in stitch state on the entire surface of the device and evenly-mixed hard particles and elastic particles each with half volume of that for the device are put into the device with certain degree of swelling; finally, wrap a thin layer of an external bag made of fine soft cloth around the device to arbitrarily pat, squeeze, clutch, rub, and touch the body and to further vitalize the skin and to achieve optimal massage and therapy effects in avoiding blood blockage for the entire body.

3. As mentioned in claim 1 of a kind of massage therapy device, the external layer of device with certain elasticity gradually increases thickness from the top end through the bottom end; furthermore, a position cork equipping air inlets and outlets chokes the stuffed opening on the container of the device; also, evenly mixed hard particles and elastic particles stuff the empty container in the device; thus, the assembled massage therapy device can mimic manual massage manner to achieve optimal massage and therapy effects under the timing control of optimal space retard, time retard, optimal force and reaction force.

4. As mentioned in claim 1 of a kind of massage therapy device, by fastening the device onto a fixture board to incorporate the specific spot, the device enhances the elasticity and comfort during the entire process of massage.
